(19) United States
(12) Patent Application Publication
(10) Pub. No.: US 2014/0145651 A1
(43) Pub. Date: May 29, 2014

(54) Battery Balancing with Reduced Circuit Complexity

(71) Applicants: Werner Schiemann, Fellbach (DE); Stefan Butzmann, Beilstein (DE)

(72) Inventors: Werner Schiemann, Fellbach (DE); Stefan Butzmann, Beilstein (DE)

(73) Assignee: Robert Bosch GmbH, Stuttgart (DE)

(21) Appl. No.: 13/698,435

(22) PCT Filed: May 11, 2011
(86) PCT No.: PCT/EP11/57580

§ 371 Date: Feb. 28, 2013

(30) Foreign Application Priority Data
May 17, 2010 (DE) 10 2010 029 013.0

(51) Int. Cl. H02J 7/00; H02P 31/00

(52) U.S. Cl. CPC H02J 7/0063; H02P 31/00
USPC 318/139; 320/118

(57) ABSTRACT

A circuit for a battery includes a number n of battery cells which are connected in series between a positive battery terminal and a negative battery terminal. The number n is a natural number greater than 1. Due to the mounting in series of the n battery cells, a number of connection points are obtained between the n battery cell. The circuit further includes a discharge element comprising a first terminal which is connected or can be connected to a first discharge line and a second terminal which is connected or can be connected to a second discharge line. The circuit also includes a number of switches which can be connected at a first terminal to a respective connection point or to one of the positive or negative battery terminals and are connected at a second terminal to the first or second discharge line.

The present invention relates to a circuit for a battery, which circuit enables cell balancing with reduced circuit complexity. The invention also relates to a battery having a circuit of this type and to a motor vehicle having an electric drive motor and a battery of this type.

### PRIOR ART

In conventional batteries, a multiplicity of battery cells are connected in series in order to produce a sufficiently high output voltage for the respective application. The series connection of the battery cells requires that a battery output current flows in all battery cells.

Owing to chemical processes during charging and discharging of the battery, the battery cells age. If one battery cell ages faster than the others, for example because of very small variations in the dimensioning or the chemical composition or the effect of temperature experienced during operation, its internal resistance increases, which may eventually lead to a reversal of the voltage and a failure of the battery cell. However, if one battery cell fails, the entire battery also fails because of the series connection of the battery cells.

It is therefore advantageous to ensure that charging and discharging of the battery cells is as matched as possible and so all of the battery cells also age at the same rate. For this purpose, it is known to carry out a so-called cell balancing in which charge is taken in a targeted manner from a battery cell with a higher energy content than another battery cell.

FIG. 1 shows a conventional battery, which allows such cell balancing. A resistor 30-1 to 30-n may be connected in parallel with the n battery cells 10-1 to 10-n via a respective switch 20-1 to 20-n in order to discharge any battery cell in a targeted manner by a desired amount. In the approach shown, it is disadvantageous that, in addition to n switches 20-1 to 20-n, n resistors 30-1 to 30-n are also required, which must optionally be cooled in order to dissipate the heat generated during the discharging from the battery. Therefore, arrangements are also known in which a single resistor as discharging element may optionally be connected to any battery cell 10-1 to 10-n. Thus, FIGS. 2 and 6 of US 2007/0090799 A1 show switch configurations, which, however, have a disadvantageously high outlay of 2*n and more switches.

### DISCLOSURE OF THE INVENTION

According to the invention, a circuit for a battery is therefore provided, which circuit has a number n of battery cells connected in series between a positive battery terminal and a negative battery terminal. The number n is a natural number greater than 1. The series connection of the n battery cells causes a number (n−1) of connection points to be formed between the n battery cells. The circuit comprises a discharge element, which has a first connection connected or able to be connected to a first discharge line and a second connection connected or able to be connected to a second discharge line. According to the invention, the circuit has a number (n+1) of switches, which are able to be connected, at a first connection, to in each case one of the (n−1) connection points or to either the positive or the negative battery terminal and which are connected, at a second connection, to either the first or second discharge line. In this way, a positive pole of a respective battery cell is able to be connected via one of the switches to a respective one selected from the first or second discharge line and a negative pole of the respective battery cell is able to be connected via one of the switches to a remaining one of the first or second discharge line.

The circuit of the invention may be combined with battery cells and batteries to form an overall system, which represents a second aspect of the invention being a battery with integrated cell-balancing function. The circuit of the invention has the advantage that a single discharge element may be used for the targeted discharging of any battery cell as part of the cell balancing, without the need for the high outlay of switches from the prior art. In the case of n battery cells connected in series, the circuit manages with only n+1 switches and nevertheless allows a single discharge element to be used for discharging any selectable battery cell of the n battery cells connected in series and optionally to be connected to the positive and the negative pole of the battery cell.

The circuit may have a control unit connected to a voltage measuring unit on the input side and to control inputs of the switches on the output side. In this case, the voltage measuring unit is able to be connected to each of the battery cells and is configured to determine a cell voltage of a battery cell connected to the voltage measuring unit and to output it to the control unit. In this case, the control unit is configured to determine a battery cell having a maximum cell voltage of the cell voltages of the battery cells and to connect the battery cell having the maximum cell voltage to the discharge element by outputting corresponding control signals to the control inputs of the switches.

The control unit may advantageously use any known methods for cell balancing. In this case, it is preferable for a battery cell having a maximum cell voltage to be determined and discharged for a certain period of time by being connected to the discharge element in order to match the cell voltage to those of the other battery cells.

The number n of battery cells may be an even number. Then in each case n/2+1 switches have a second connection which is connected to the first discharge line, and n/2 switches have a second connection which is connected to the second discharge line.

Alternatively, the number n of battery cells may be an odd number. In this situation, in each case (n+1)/2 switches have a second connection which is connected to the first discharge line, and (n+1)/2 switches have a second connection which is connected to the second discharge line.

The discharge element may be a resistive element. Such a resistive element converts the current of the discharged battery cell into heat, and so the amount of energy connected therewith can no longer be used for the actual purpose of the battery. In any case, a better electromagnetic compatibility is afforded compared to inductive discharge elements, for example, which can transfer charge from one battery cell to another.

In the battery of the second aspect of the invention, the battery cells are particularly preferably lithium-ion battery cells. Lithium-ion battery cells have a high cell voltage and a high ratio of stored energy to volume occupied.

A further aspect of the invention relates to a motor vehicle having an electric drive motor for driving the motor vehicle and a battery according to the second aspect of the invention connected or able to be connected to the electric drive motor. However, the battery is not restricted to such an intended application, rather it can also be used in other electrical systems.

### DRAWINGS

Exemplary embodiments of the invention are described in more detail with reference to the drawings and the following description, wherein the same reference signs designate the same or similar elements. In the figures:

FIG. 1 shows a battery with cell balancing according to the prior art,

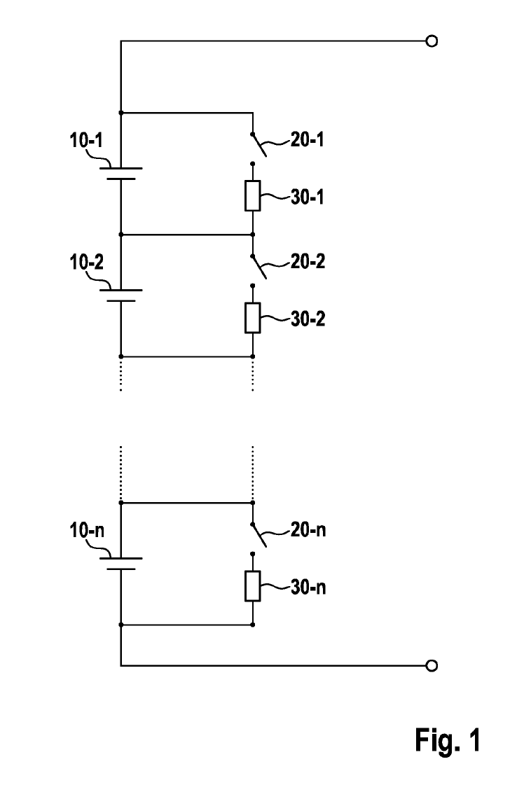

FIG. 2 shows a first exemplary embodiment of the invention,

FIG. 3 shows a second exemplary embodiment of the invention with an even number of battery cells, and

FIG. 4 shows a third exemplary embodiment of the invention with an odd number of battery cells.

### EMBODIMENTS OF THE INVENTION

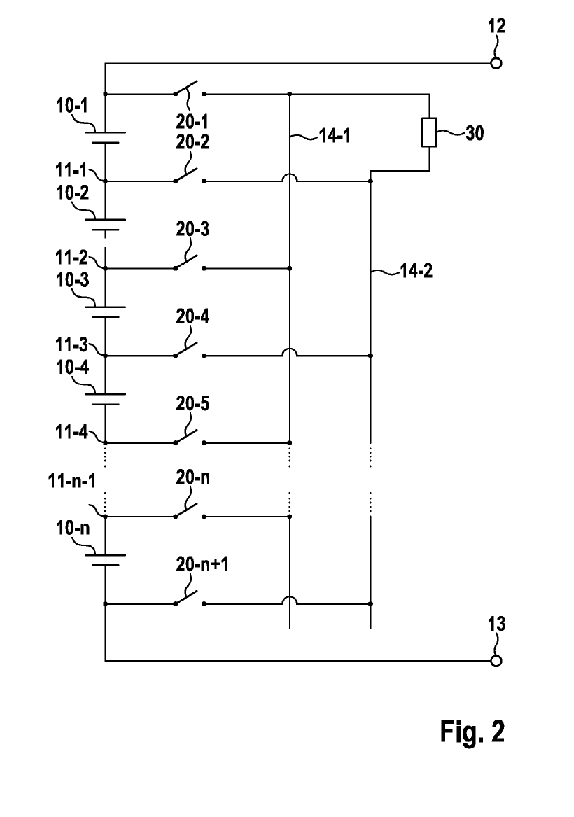

FIG. 2 shows a first exemplary embodiment of the invention. A number n of battery cells 10-1 to 10-n are connected in series between a positive battery terminal 12 and a negative battery terminal 13, as a result of which (n−1) connection points 11-1 to 11-n−1 are formed between the n battery cells 10-1 to 10-n. In all of the exemplary embodiments, the battery cells themselves do not necessarily constitute a part of the invention, rather the invention is realized in the interconnection thereof. Even though a battery having battery cells is addressed in the following text, only the circuit, which is connected or intended to be connected to the battery cells and advantageously provides the cell balancing function, can be meant. This circuit may be a commercial product in its own right and only connected to the battery cells at a later point in time.

According to the invention, for the exemplary embodiment of FIG. 2 with n battery cells 10-1 to 10-n, only (n+1) switches 20-1 to 20-n+1 are required to connect a discharge element 30, which is embodied as an ohmic resistor in the example, to any of the n battery cells 10-1 to 10-n. The switches 20-1 to 20-n+1 are connected on the input side to a respectively assigned connection point 11-1 to 11-n−1 or the positive battery terminal 12 or the negative battery terminal 13. On the output side, the switches 20-1 to 20-n+1 are connected alternately according to their sequence to a first discharge line 14-1 or a second discharge line 14-2, which for their part are connected to respective connections of the discharge element 30. A battery cell 10-m, wherein 0<m≦n, can be connected to the discharge element 30 when the switches 20-m and 20-m+1 are closed and the remaining switches are open. In this case, depending on m, the switch 20-m may connect a positive pole or a negative pole of a battery cell to the discharge line 14-1 or 14-2 assigned to the switch 20-m, and so, depending on which battery cell 10-1 to 10-n is to be discharged, from the point of view of the discharge element 30 different signs of the cell voltage present at the discharge element 30 may occur.

This fact is irrelevant, however, because the discharge element 30 does not have a directional dependence with respect to the currents flowing through it. The invention makes advantageous use of this.

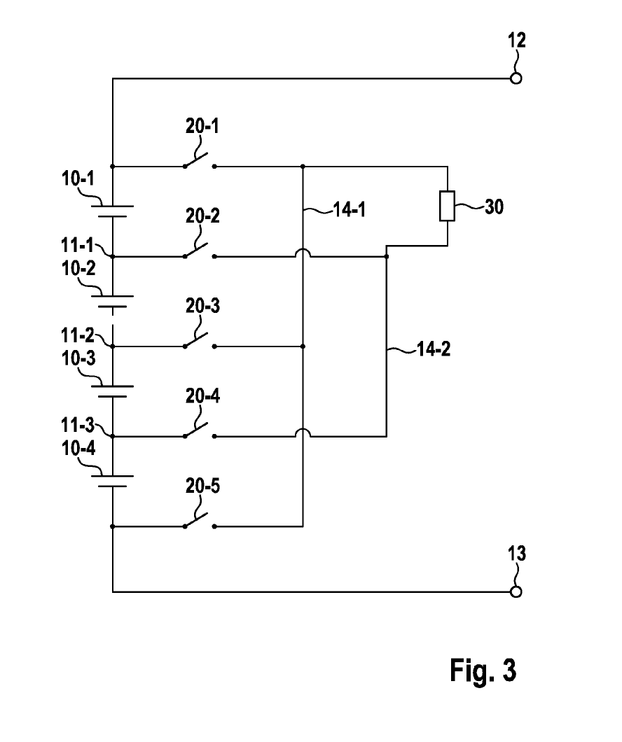

FIG. 3 shows a second exemplary embodiment of the invention with an even number of battery cells. The illustrated example shows four battery cells 10-1 to 10-4, wherein three connection points 11-1 to 11-3 are formed as a result of the series connection of the battery cells 10-1 to 10-4. According to the invention, five switches 20-1 to 20-5 are sufficient for each of the four battery cells 10-1 to 10-4 to be able to be connected to the discharge element 30. The odd number of switches 20-1 to 20-5 divides into two sets S₁ and S₂ of three and two switches respectively, wherein S₁ contains the switches 20-1, 20-3 and 20-5 and S₂ contains the switches 20-2 and 20-4. Of course, the exemplary embodiment shown can have any even number of battery cells, wherein the resulting odd number of switches basically divides into two sets S₁ and S₂ of switches which differ in their respective number of switches by only 1. If, in the case of an even number n of battery cells, the switches 20-1 to 20-n+1 are numbered consecutively according to their sequence from the positive battery terminal 12 to the negative battery terminal 13, the odd-numbered switches 20-1, 20-3, . . . , 20-n+1 are connected to the first discharge line 14-1 and the even-numbered switches 20-2, 20-4, . . . , 20-n are connected to the second discharge line 14-2.

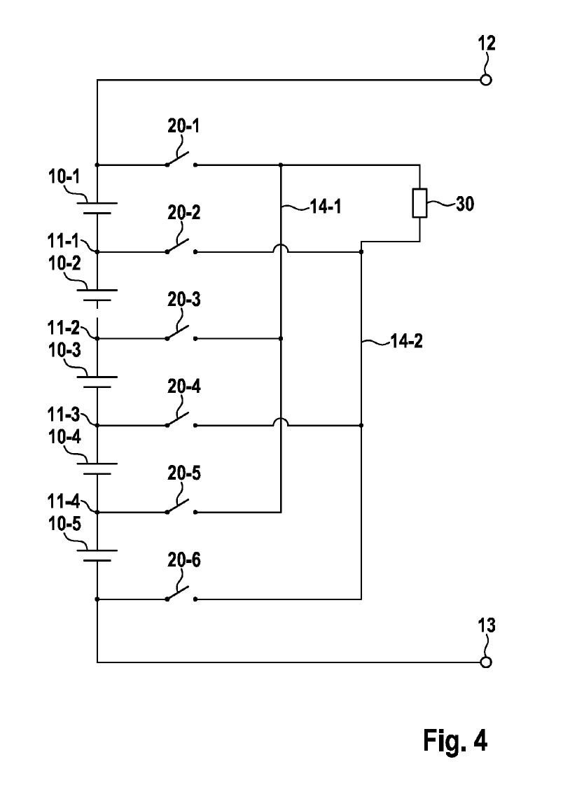

FIG. 4 shows a third exemplary embodiment of the invention with an odd number of battery cells. Owing to the odd number (five in the example shown) of battery cells 10-1 to 10-5, there is an even number (six in the example shown) of switches 20-1 to 20-6 required according to the invention. The switches divide into two sets S₁ and S₂. which each contain an equal number of switches. The number of battery cells may be any odd number. If, in the case of an odd number n of battery cells, the switches 20-1 to 20-n+1 are numbered consecutively according to their sequence from the positive battery terminal 12 to the negative battery terminal 13, the odd-numbered switches 20-1, 20-3, . . . , 20-n are connected to the first discharge line 14-1 and the even-numbered switches 20-2, 20-4, . . . , 20-n+1 are connected to the second discharge line 14-2.

1. A circuit for a battery comprising:
a first number (n) of battery cells connected in series between a positive battery terminal and a negative battery terminal in such a way that a second number (n−1) of connection points are formed between the first number (n) of battery cells, wherein the first number (n) is a natural number greater than 1;
a discharge element, which has (i) a first connection connected or able to be connected to a first discharge line and (ii) a second connection connected or able to be connected to a second discharge line; and
a plurality of switches,
wherein a third number (n+1) of the switches of the plurality of switches are able to be connected, at a first connection, to in each case one of the second number (n−1) of connection points or to either the positive battery terminal or the negative battery terminal and which are connected, at a second connection, to either the first discharge line or the second discharge line,
wherein a positive pole of a respective one of the battery cells is able to be connected via one of the switches of the plurality of switches to a respective one selected from the first discharge line or the second discharge line, and
wherein a negative pole of the respective one of the battery cells is able to be connected via one of the switches of the plurality of switches to a remaining one of the first discharge line or the second discharge line.

2. The circuit as claimed in claim 1, further comprising:
a control unit connected to a voltage measuring unit on an input side and to control inputs of the switches on an output side,
wherein the voltage measuring unit is able configured to be connected to each of the battery cells and is further configured to determine a cell voltage of a battery cell connected to the voltage measuring unit and to output it to the control unit, and
wherein the control unit is configured to determine a battery cell having a maximum cell voltage of a plurality of cell voltages of the battery cells and to connect the battery cell having the maximum cell voltage to the discharge element by outputting corresponding control signals to the control inputs of the plurality of switches.

3. The circuit as claimed in claim 1, wherein:
the first number (n) is an even number,
in each case n/2+1 of the switches of the plurality of switches have a second connection which is connected to the first discharge line, and
n/2 switches of the plurality of switches have a second connection which is connected to the second discharge line.

4. The circuit as claimed in claim 1, wherein:
the first number (n) is an odd number,
in each case (n+1)/2 of the switches of the plurality of switches have a second connection which is connected to the first discharge line, and
(n+1)/2 of the switches of the plurality of switches have a second connection which is connected to the second discharge line.

5. The circuit as claimed in claim 1, wherein the discharge element is a resistive element.

6. A battery comprising:
a circuit; and
a first number (n) of battery cells connected in series between a positive battery terminal and a negative battery terminal,
wherein the circuit includes
a first number (n) of battery cells connected in series between the positive battery terminal and the negative battery terminal in such a way that a second number (n−1) of connection points are formed between the first number (n) of battery cells, wherein the first number (n) is a natural number greater than 1,
a discharge element, which has (i) a first connection connected or able to be connected to a first discharge line and (ii) a second connection connected or able to be connected to a second discharge line, and
a plurality of switches,
wherein a third number (n+1) of the switches of the plurality of switches are able to be connected, at a first connection, to in each case one of the second number (n−1) of connection points or to either the positive battery terminal or the negative battery terminal and which are connected, at a second connection, to either the first discharge line or second discharge line,
wherein a positive pole of a respective one of the battery cells is able to be connected via one of the switches of the plurality of switches to a respective one selected from the first discharge line or the second discharge line, and
wherein a negative pole of the respective one of the battery cells is able to be connected via one of the switches of the plurality of switches to a remaining one of the first discharge line or the second discharge line.

7. The battery of claim 6, wherein the battery cells are lithium-ion battery cells.

8. A motor vehicle comprising:
an electric drive motor for driving configured to drive the motor vehicle; and
a battery connected or able to be connected to the electric drive motor,
wherein the battery includes (i) a circuit, and a first number (n) of battery cells connected in series between a positive battery terminal and a negative battery terminal,
wherein the circuit includes
a first number (n) of battery cells connected in series between the positive battery terminal and the negative battery terminal in such a way that a second number (n−1) of connection points are formed between the first number (n) of battery cells, wherein the first number (n) is a natural number greater than 1,
a discharge element, which has (i) a first connection connected or able to be connected to a first discharge line and (ii) a second connection connected or able to be connected to a second discharge line, and
a plurality of switches,
wherein a third number (n+1) of the switches of the plurality of switches are able to be connected, at a first connection, to in each case one of the second number (n−1) of connection points or to either the positive battery terminal or the negative battery terminal and which are connected, at a second connection, to either the first discharge line or the second discharge line,
wherein a positive pole of a respective one of the battery cells is able to be connected via one of the switches of the plurality of switches to a respective one selected from the first discharge line or the second discharge line, and
a negative pole of the respective one of the battery cells is able to be connected via one of the switches of the plurality of switches to a remaining one of the first discharge line or the second discharge line.
